(19) United States
(12) Patent Application Publication
(10) Pub. No.: US 2013/0108826 A1
(43) Pub. Date: May 2, 2013

(54) PRODUCTION OF HIGHLY CONDUCTIVE CARBON NANOTUBE-POLYMER COMPOSITES

(71) Applicants: Divya Kannan Chakravarthi, Wappingers Falls, NY (US); Ahmad Salman, Houston, TX (US); Enrique V. Barrera, Houston, TX (US); Michael T. Searfass, Bakersfield, CA (US); Kyle Kissell, Manvel, TX (US)

(72) Inventors: Divya Kannan Chakravarthi, Wappingers Falls, NY (US); Ahmad Salman, Houston, TX (US); Enrique V. Barrera, Houston, TX (US); Michael T. Searfass, Bakersfield, CA (US); Kyle Kissell, Manvel, TX (US)

(73) Assignee: William Marsh Rice University, Houston, TX (US)

(21) Appl. No.: 13/640,028

(22) PCT Filed: Apr. 6, 2011
(86) PCT No.: PCT/US11/31393

§ 371 Date: Jan. 14, 2013

Related U.S. Application Data
(60) Provisional application No. 61/321,267, filed on Apr. 6, 2010.

(51) Int. Cl. H01B 1/24; H01B 13/00

(52) U.S. Cl. CPC H01B 1/24; H01B 13/0036; Y10S 977/75; Y10S 977/752; B82Y 30/00
USPC 428/114; 264/437; 428/221; 977/750; 977/752; 977/778

(57) ABSTRACT

In various embodiments, the present invention provides method of forming composites. Such methods generally comprise: (1) applying carbon nanotubes onto a system, wherein the system comprises at least one of an electric field or a magnetic field, and wherein the at least one electric field or magnetic field unidirectionally aligns the carbon nanotubes; and (2) applying a polymer onto the carbon nanotubes while the carbon nanotubes are unidirectionally aligned by the at least one electric field or magnetic field. The application of the polymer onto the carbon nanotubes forms composites that comprise unidirectionally aligned carbon nanotubes embedded in the polymer. In further embodiments, the present invention provides polymer composites formed by the methods of the present invention. Such polymer composites generally comprise: (1) a polymer, wherein the polymer forms a polymer matrix; and (2) a plurality of carbon nanotubes, wherein the carbon nanotubes are unidirectionally aligned and embedded in the polymer matrix.

### CROSS-REFERENCE TO RELATED APPLICATIONS

This application claims priority to U.S. Provisional Patent Application No. 61/321,267, filed on Apr. 6, 2010. The entirety of this application is incorporated herein by reference.

### STATEMENT REGARDING FEDERALLY SPONSORED RESEARCH

This invention was made with government support under Grant No. DE-AC26-07NT42677, awarded by the U.S. Department of Energy. The Government has certain rights in the invention.

### BACKGROUND OF THE INVENTION

Composites containing carbon nanotubes find applications in many fields. However, current methods of making such composites suffer from various limitations, including limited carbon nanotube dispersion and alignment. Such limitations may in turn affect various key attributes of the formed composites, including electrical conductivity. Therefore, there is currently a need to develop more effective methods of forming composites that contain dispersed and aligned carbon nanotubes.

### BRIEF SUMMARY OF THE INVENTION

In various embodiments, the present invention provides methods of forming composites. Such methods generally comprise: (1) applying carbon nanotubes onto a system, wherein the system comprises at least one of an electric field or a magnetic field, and wherein the at least one electric field or magnetic field unidirectionally aligns the carbon nanotubes; and (2) applying a polymer onto the carbon nanotubes while the carbon nanotubes are unidirectionally aligned by the at least one electric field or magnetic field. The application of the polymer onto the carbon nanotubes forms composites that comprise unidirectionally aligned carbon nanotubes embedded in the polymer.

In some embodiments, the unidirectionally aligned carbon nanotubes comprise carbon nanotubes that are horizontally aligned in the direction of the at least one electric field or magnetic field. In further embodiments, the methods of the present invention may be repeated more than once to form polymer composites with a plurality of layers. In such embodiments, each layer comprises unidirectionally aligned carbon nanotubes embedded in a polymer.

In additional embodiments, the systems used to make polymer composites of the present invention comprise a vacuum filtration system with a filter. In such embodiments, the carbon nanotubes and the polymer are sequentially applied onto a surface of the filter.

In further embodiments, the present invention provides polymer composites formed by the methods of the present invention. Such polymer composites generally comprise: (1) a polymer that can form a polymer matrix; and (2) a plurality of carbon nanotubes that are unidirectionally aligned and embedded in the polymer matrix.

In various embodiments, the methods of the present invention may be used to form polymer composites for use as highly conductive continuous wires, continuous fibers, tapes, and thin films. Such composites can find numerous applications, including electrical, mechanical and thermal applications.

### BRIEF DESCRIPTION OF THE FIGURES

In order that the manner in which the above recited and other advantages and objects of the invention are obtained, a more particular description of the invention briefly described above will be rendered by reference to specific embodiments thereof, which are illustrated in the appended Figures. Understanding that these Figures depict only typical embodiments of the invention and are therefore not to be considered limiting of its scope, the invention will be described with additional specificity and detail through the use of the accompanying Figures in which:

FIG. 1 shows an illustration of a vacuum system 10 with filter chamber 32 that can be used for the formation of the composites of the present invention in some embodiments.

FIG. 2 shows exemplary illustrations of filter chamber 32 in vacuum system 10, and methods of utilizing the chambers to make composites.

FIG. 2A shows a diagram of an electric field-vacuum spray (EFVS) processing method that utilizes filter chamber 32.

FIG. 2B shows a side view of the diagram in FIG. 2A.

FIG. 2C shows a schematic for a wire set up and a sample under the influence of an electric field in filter chamber 32. In this embodiment, filter chamber 32 has a wider area.

FIG. 2D shows a photograph of a lab scale set up of a vacuum system 10.

FIG. 3 shows a schematic of a vacuum system 50 that can be used for the formation of the composites of the present invention in additional embodiments.

FIG. 4 is a photograph of formed composite samples.

FIG. 5 shows the impact of the electric field strength on the electrical resistivity of composite samples that contained 10 wt % single-wall carbon nanotubes (SWNT) dispersed in medium density polyethylene (MDPE) (SWNT/MDPE composites). The composites were obtained by using the vacuum systems of the present invention. Copper plates were utilized as the electrode material.

FIG. 6 shows scanning electron microscopy (SEM) images of various 10 wt % SWNT/MDPE composites obtained in accordance with the methods of the present invention that utilized different electric field strengths.

FIG. 6A shows an SEM image of a 10 wt % SWNT/MDPE composite sample processed with an electric field strength of 111 V/cm.

FIG. 6B shows an SEM image of a 10 wt % SWNT/MDPE composite sample processed with an electric field strength of 1,111 V/cm.

FIG. 7 shows SEM images of additional 10 wt % SWNT/MDPE composites obtained in accordance with the methods of the present invention that utilized different types of electrodes.

FIG. 7A shows an SEM image of a 10 wt % SWNT/MDPE composite sample processed using graphite electrodes in a vacuum system.

FIG. 7B shows an SEM image of a 10 wt % SWNT/MDPE composite sample processed using indium tin oxide coated glass electrodes in a vacuum system.

FIG. 8 shows SEM images of aligned (FIG. 8A) and unaligned (FIG. 8B) 10 wt % SWNT/MDPE composites.

FIG. 9 shows additional SEM images of 10 wt % SWNT/MDPE composites. The images show aligned and well dispersed nanotubes that can provide a continuous network for electron flow.

FIG. 9A shows SEM images of the composites at 7,500× (left panel) and 15,000× (right panel).

FIG. 9B shows SEM images of the composites at ˜35,000× (left panel) and ˜150,000× (right panel). The higher magnifications show that the carbon nanotubes are unidirectionally aligned in the composites.

FIG. 10 shows Polarized Raman spectra of 10 wt % SWNT/MDPE composites that are aligned (FIG. 10A) and non aligned (FIG. 10B). The spectra show an increase in the G peak intensity for the G_{perpendicular} as compared to Gₚₐᵣₐₗₗₑₗ.

FIG. 11 shows Raman mapping of the “G peak” intensities of 10 wt % SWNT/MDPE of aligned composites (FIG. 11A) and composites aligned in a perpendicular direction to the polarized laser beam (FIG. 11B). The spectra indicate a reduction in intensity, as shown by the map in FIG. 11B due to the alignment.

### DETAILED DESCRIPTION OF EXEMPLARY EMBODIMENTS

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes only and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

In various embodiments, the present invention provides methods of forming composites. Such methods generally comprise: (1) applying carbon nanotubes onto a system, wherein the system comprises at least one of an electric field or a magnetic field, and wherein the at least one electric field or magnetic field unidirectionally aligns the carbon nanotubes; and (2) applying a polymer onto the carbon nanotubes while the carbon nanotubes are unidirectionally aligned by the at least one electric field or magnetic field. The application of the polymer onto the carbon nanotubes forms composites that comprise unidirectionally aligned carbon nanotubes embedded in the polymer.

The methods of the present invention can have numerous embodiments. For instance, in some embodiments, the carbon nanotubes are applied to a system while an electric field or a magnetic field in the system is being actuated. In further embodiments, an electric field or magnetic field may first be actuated before carbon nanotubes are applied onto the system. In additional embodiments, both an electric field and a magnetic field may be actuated during composite formation. In further embodiments, the methods of the present invention may be repeated numerous times to form composites with multiple layers.

In further embodiments of the present invention, the systems used to make composites is a vacuum filtration system with a filter. In various embodiments, the carbon nanotubes and the polymer are sequentially applied onto a surface of the filter. In further embodiments, each applying step may be followed by a filtration step to filter any solvents or solutions associated with the carbon nanotubes or polymers.

In additional embodiments, the systems of the present invention may further comprise a plurality of parallel conductive plates or adjustable conductive plates. Such parallel or adjustable conductive plates can allow for adjusting a direction of the electric field or magnetic field in order to form unidirectionally aligned carbon nanotubes at various desired angles. In some embodiments, such desired angles may range from about 0° to about 135° from the direction of an electric field or magnetic field. In some embodiments, the unidirectionally aligned carbon nanotubes comprise carbon nanotubes that are horizontally aligned in the direction of an electric field or magnetic field (i.e., at an angle of 0°).

In further embodiments, the methods of the present invention may be repeated more than once to form polymer composites with a plurality of layers. In such embodiments, each layer comprises unidirectionally aligned carbon nanotubes embedded in a polymer.

In further embodiments, the present invention provides polymer composites that are formed by the methods of the present invention. Such polymer composites generally comprise: (1) a polymer, wherein the polymer forms a polymer matrix; and (2) a plurality of carbon nanotubes that are unidirectionally aligned and embedded in the polymer matrix.

Various aspects of the present invention will now be described in more detail with reference to specific and non-limiting examples.

Composite Formation

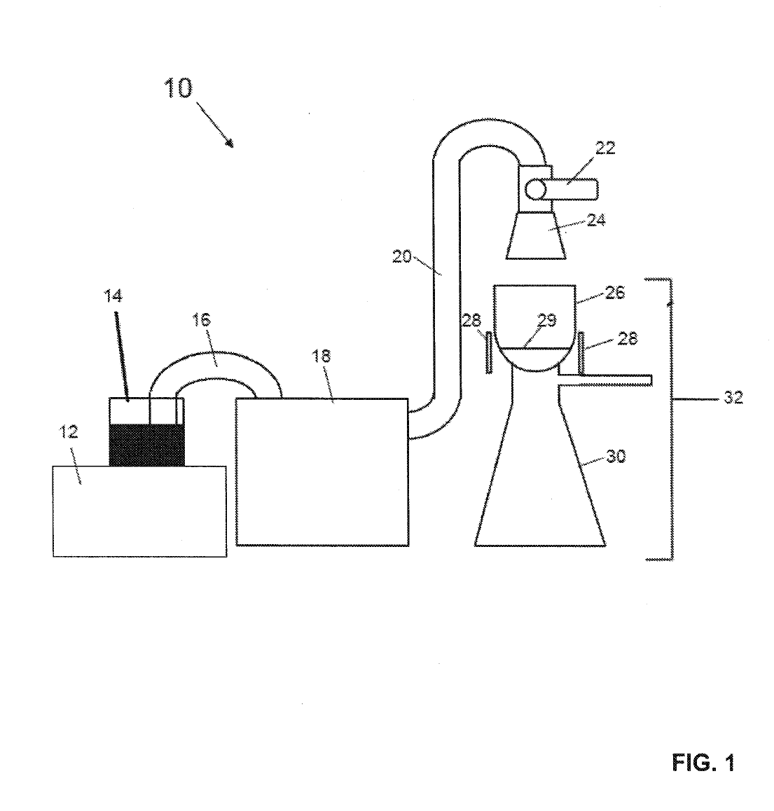

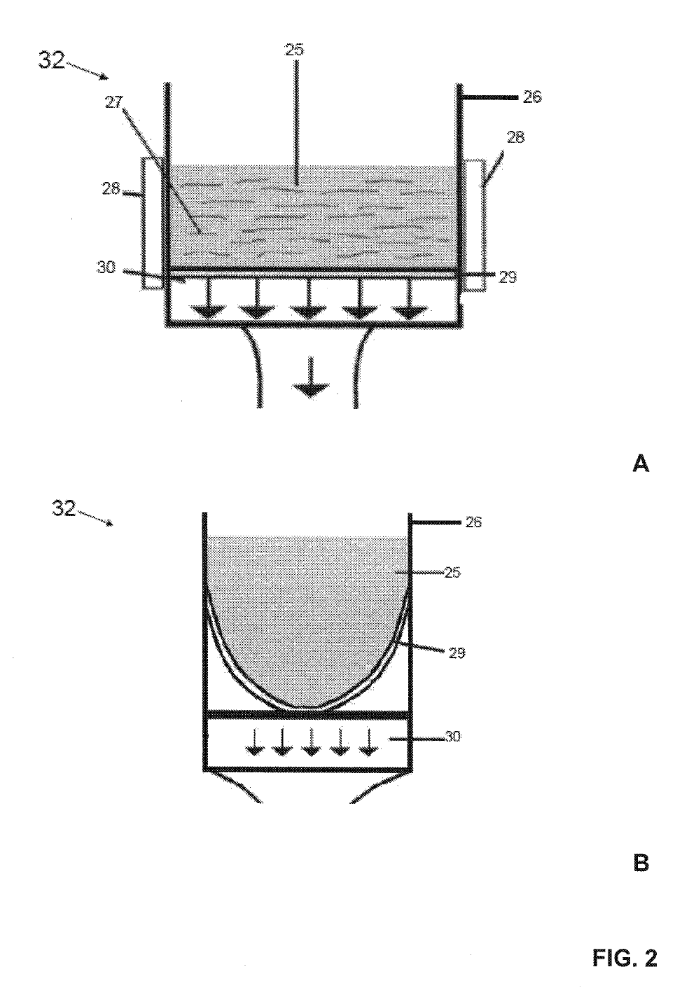

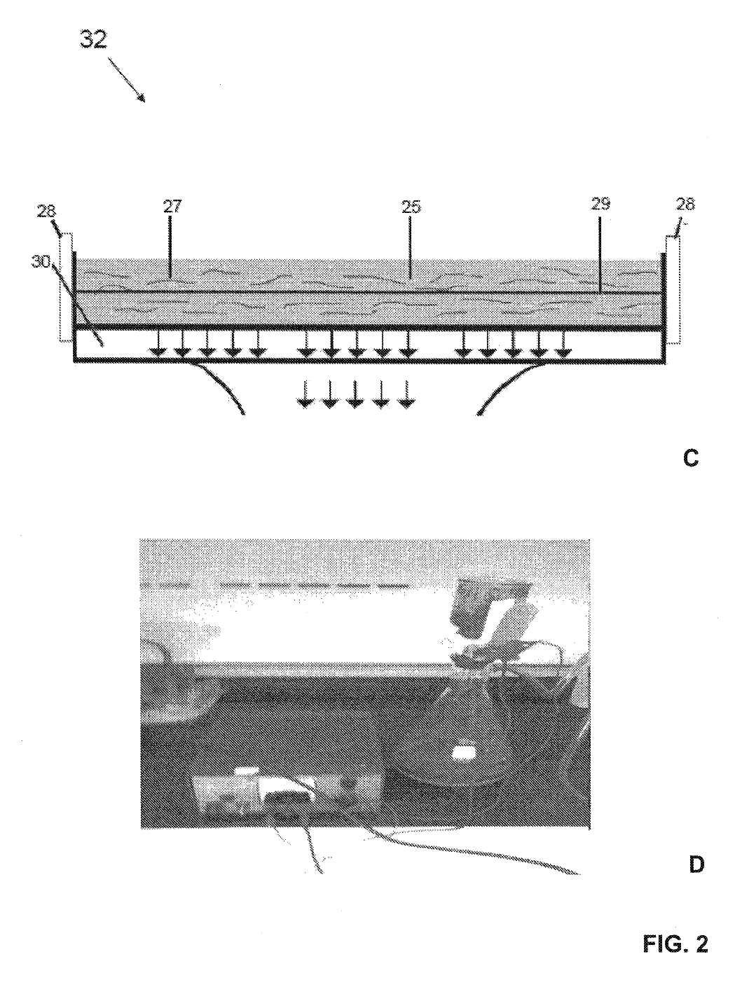

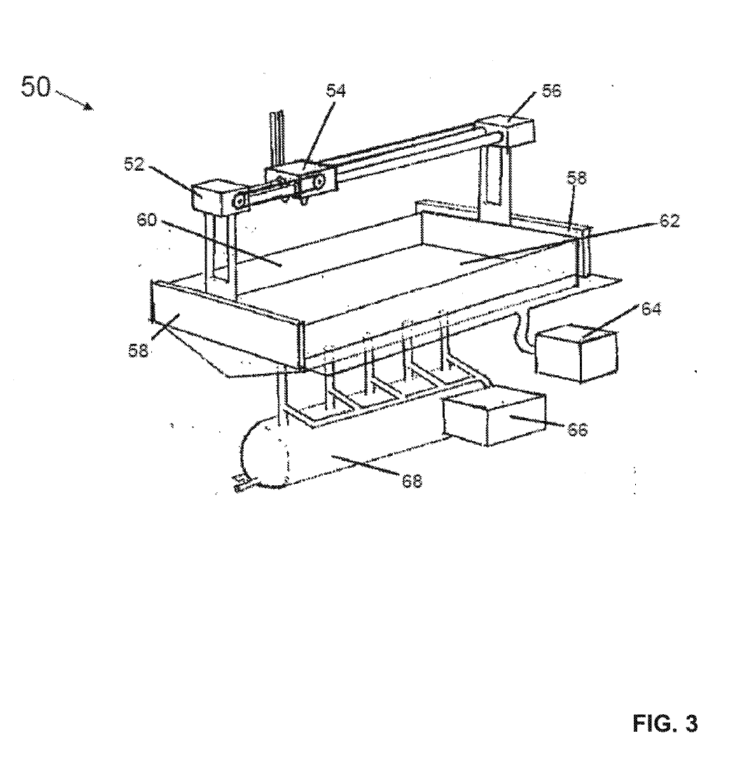

As set forth previously, various systems may be utilized to form composites in accordance with the methods of the present invention. As also set forth previously, the systems of the present invention may be vacuum based systems. For instance, in various specific embodiments, vacuum system 10 illustrated in FIGS. 1-2 may be used. In further embodiments, Vacuum system 50 illustrated in FIG. 3 may be used.

Referring now to FIG. 1, vacuum system 10 generally consists of sonicator 12, container 14, first tubing 16, pump 18, second tubing 20, valve 22, spray nozzle 24, and filter chamber 32. More detailed illustrations of filter chamber 32 are shown in FIGS. 2A-2C.

Filter chamber 32 contains collection chamber 26, conductive plates 28 on each side of the collection chamber, filter 29 (e.g., a 0.2 micron PTFE membrane), and collection flask 30. Though not shown, conductive plates 28 are connected to a power supply, which can be used to apply an electric or magnetic field between the plates.

The vacuum systems of the present invention may also be housed within a fume hood in order to prevent circulation of aerosolized toxic solvents from affecting individuals. In further embodiments, high temperature conductive tapes may secure electrical wirings to the conductive plates.

In operation, a carbon nanotube solution is first placed in container 14. Sonicator 12 is then actuated to help maintain the dispersion of the carbon nanotubes in the solution. Additional methods of dispersing carbon nanotubes may also be used (e.g., ultrasonication, mixing, and/or decanting). Next, pump 18 is actuated to result in the flow of the carbon nanotube solution from container 14 onto spray nozzle 24 through tubings 16 and 20. The carbon nanotubes are then sprayed onto filter 29.

Desirably, the spraying occurs while filter chamber 32 is under an electric field produced by conductive plates 28 through a power supply. More desirably, filter chamber 32 is also under a vacuum pressure. The vacuum pressure results in the filtration of the carbon nanotube solution. Likewise, the electric field results in the unidirectional alignment of the carbon nanotubes on the filter membrane such that the carbon nanotubes become horizontally aligned in the direction of the electric field. See, e.g., Carbon nanotubes 27 in FIGS. 2A-2C.

Thereafter, the above cycle is repeated by placing a polymer solution in container 14. The repetition of the above process results in the spraying of the polymers onto filter 29, which now contain horizontally aligned carbon nanotubes. The vacuum pressure results in the filtration of the polymer solvent and the retainment of the polymer on the filter to form a polymer matrix. This results in the formation of composites that contain unidirectionally aligned carbon nanotubes embedded in the polymer matrix.

In further embodiments, the polymer and the carbon nanotubes can be sprayed at the same time. In additional embodiments, the process may be repeated numerous times in order to obtain composites with multiple layers.

A photograph of a lab scale set up of a vacuum system 10 is shown in FIG. 2D. A person of ordinary skill in the art will also recognize that additional vacuum set ups can be built with different sizes and shapes based on a desired requirement.

For instance, FIG. 3 illustrates an alternative vacuum set up as vacuum system 50. Vacuum system 50 in this embodiment generally consists of motors 52 and 56, mechanical spray 54, conductive plates 58, collection chamber 60, filter 62, power supply 64, vacuum pump 66, and solvent collection tank 68. The mechanical spray 54 in this embodiment has two inlets. One inlet can be used for the spraying of the polymer. The other inlet can be used for the spraying of the nanotube. As envisioned by persons of ordinary skill in the art, the operation of vacuum system 50 may also have various embodiments.

Formed Composites

In general, the composites that are formed by utilizing the methods and systems of the present invention comprise: (1) polymers that form a polymer matrix; and (2) unidirectionally aligned carbon nanotubes that are embedded in the polymer matrix. In some embodiments, the unidirectionally aligned carbon nanotubes are horizontally aligned carbon nanotubes, where the carbon nanotubes are horizontally aligned in the direction of the applied electric field and/or magnetic field.

In some embodiments, the unidirectionally aligned carbon nanotubes can also be connected to one another. In some embodiments, such connections are localized rather than extensive. For instance, in some embodiments, the carbon nanotubes may be connected to one another at their junctions or ends.

In some embodiments, the unidirectionally aligned carbon nanotubes are aligned at a desired angle. In some embodiments, the desired angle ranges from about 0° to about 135° from the direction of the electric or magnetic field.

In some embodiments, the unidirectionally aligned carbon nanotubes comprise a continuous network of carbon nanotubes. In such embodiments, the unidirectionally aligned carbon nanotubes may be connected to one another (as previously described).

In further embodiments, the composites of the present invention may have more than one layer as a result of the repetition of the methods of the present invention. In such embodiments, each layer comprises unidirectionally aligned carbon nanotubes that are embedded in a polymer matrix.

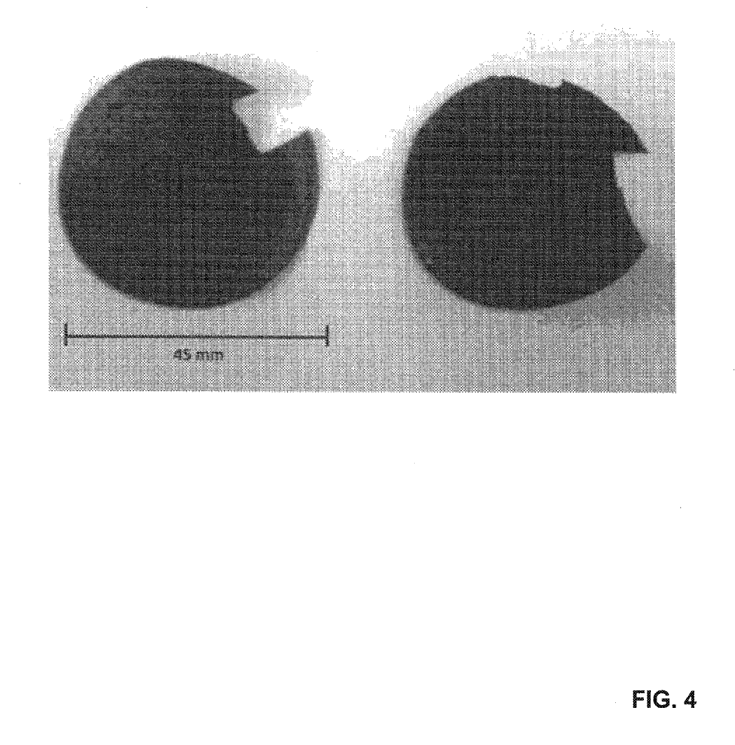

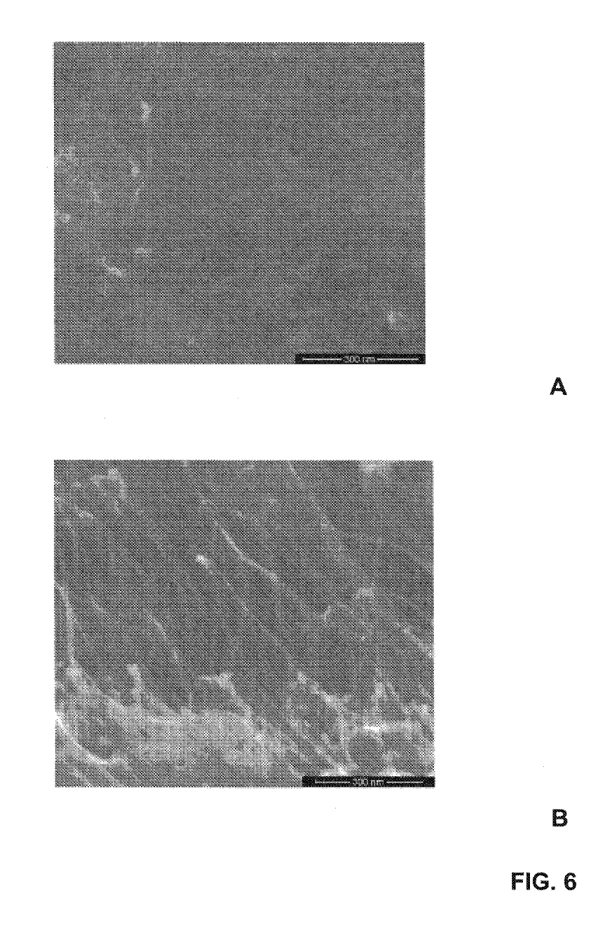

A photographic depiction of a composite formed in accordance with the present invention is shown in FIG. 4. SEM images of such composites showing the unidirectionally aligned carbon nanotubes within them are shown in FIGS. 6-9. As set forth in more detail below, the highly aligned carbon nanotubes in polymer matrices significantly improve the electrical, mechanical and thermal properties of the composites of the present invention.

As also set forth below in more detail below, the methods and systems of the present invention can have numerous embodiments. For instance, various carbon nanotubes, polymers, electric fields, magnetic fields, and filters may be utilized.

Carbon Nanotubes

Various forms of carbon nanotubes may be utilized with the methods, systems and composites of the present invention. In some embodiments, the utilized carbon nanotubes are at least one of single-wall carbon nanotubes, double-wall carbon nanotubes, multi-wall carbon nanotubes, ultrashort carbon nanotubes, and combinations thereof. In some embodiments, the carbon nanotubes are functionalized carbon nanotubes. In some embodiments, the carbon nanotubes are metal-coated carbon nanotubes. In further embodiments, the carbon nanotubes are pristine carbon nanotubes.

In more specific embodiments, the carbon nanotubes are single-wall carbon nanotubes. In further embodiments, the carbon nanotubes are Hipco-purified carbon nanotubes (e.g., HiPC® purified single-wall carbon nanotubes). In further embodiments, the carbon nanotubes may be GC 100 purified carbon nanotubes.

Carbon nanotubes that are to be applied to various systems of the present invention may be in a solution, such as a dispersant. Such solutions may also comprise surfactants to aid in the dispersion. Non-limiting examples of suitable surfactants include LDS, SDS, zwitterionic surfactants, cationic surfactants, anionic surfactants, and the like.

In more specific embodiments, the carbon nanotubes may be dispersed in N-methylpyrrolidone (NMP). Additional suitable carbon nanotube solutions can also be envisioned by persons of ordinary skill in the art.

In some embodiments, applying carbon nanotubes onto a system entails spraying the carbon nanotubes onto the system. Various spraying techniques may be utilized. In some embodiments, the spraying may involve electrospraying. In additional embodiments, the spraying may involve manual or mechanical spraying.

Additional methods of applying carbon nanotubes onto a system can also be envisioned. Such methods may include, without limitation, spin-coating, drop-casting, spray coating, dip coating, physical application, sublimation, blading, inkjet printing, screen printing, direct placement, or thermal evaporation.

Polymers

Various polymers may be used with the methods, systems and composites of the present invention. In various embodiments, the polymers are at least one of polyethylenes, polyurethanes, polystyrenes, polyvinyl chlorides (PVC), polymethyl methacrylates (PMMA), polyvinyl alcohols (PVA), polyethylene glycols (PEGs), poly(ethylene terephthalate) (PET), epoxy polymers, and combinations thereof. In more specific embodiments, the polymer is a medium density polyethylene (MDPE).

Desirably, the polymers of the present invention may be dissolved and/or melted in a solvent in order to decrease a polymer's viscosity and provide more effective application onto the systems of the present invention. The polymers of the present invention may also be dissolved in various solvents. Examples of such solvents include, without limitation, toluenes, xylenes, dimethylformamides, methylpyrrolidones, chloroform, benzenes, and combinations thereof. In more specific embodiments, the solvent in which the polymer is dissolved in is dichlorbenzene.

A person of ordinary skill in the art will also recognize that various embodiments exist for applying polymers onto a system. For instance, in some embodiments, the application of polymers onto the system entails spraying the polymers onto the system by various techniques described previously. Additional methods of applying polymers onto a system can also be envisioned by persons of ordinary skill in the art. Such methods may include, without limitation, spin-coating, drop-casting, spray coating, dip coating, physical application, sublimation, blading, inkjet printing, screen printing, direct placement, or thermal evaporation.

Electric Fields

Various methods may also be used to apply electric fields to the systems of the present invention. For instance, in some embodiments, the electric field may be derived from conductive plates that are connected to a voltage source. Non-limiting examples of conductive plates include conductive plates derived from at least one of copper, aluminum, graphite, tin oxide, and combinations thereof. The use of other suitable conductive plates can also be envisioned by persons of ordinary skill in the art.

In additional embodiments, the electric field may be derived from electrodes that are connected to a voltage source. Additional embodiments for generating electric fields can also be envisioned by persons of ordinary skill in the art.

A person of ordinary skill in the art can also envision the application of different electric field strengths. In some embodiments, the applied electric field strength may be from about 100 V/cm to about 1,500 V/cm. In more specific embodiments, the applied electric field strength may be from about 110 V/cm to about 1,200 V/cm. In further embodiments, the applied electric field strength may be about 111 V/cm, about 222 V/cm, about 556 V/cm or about 1,111 V/cm.

Magnetic Fields

In additional embodiments, the carbon nanotubes of the present invention may be aligned by the utilization of magnetic fields. Magnetic fields may be applied alone or in conjunction with electric fields in various embodiments of the present invention.

A person of ordinary skill in the art will also recognize that various methods may be used to apply magnetic fields to the systems of the present invention. In some embodiments, the magnetic field may be derived from the previously-described conductive plates that are connected to a voltage source. In further embodiments, the magnetic fields may be derived from magnetic plates, coils, and/or solenoids. Additional sources of magnetic fields can also be envisioned by persons of ordinary skill in the art.

Filters

Various filters may also be used in conjunction with the methods and systems of the present invention. In some embodiments, the filter is a 0.2 micron filter membrane. In more specific embodiments, the filter is a 0.2 micron polytetrafluoroethylene (PTFE) membrane. In further embodiments, the filter is a PTFE membrane with a diameter of about 47 mm and a pore size of about 45 μm.

The use of additional filters with different pore sizes can also be envisioned. For instance, in some embodiments, the filter may have a pore size that ranges from about 0.01 μm to about 50 μm. In more specific embodiments, the filter may have a pore size that ranges from about 0.05 μm to about 0.2 μm. In a more preferred embodiment, the filter has a pore size of about 0.2 μm. Other suitable filter pore sizes can also be envisioned by persons of ordinary skill in the art.

The filters utilized in the systems and methods of the present invention may also be derived from various sources. For instance, in some embodiments, the filters may be derived from various polymers (e.g., PTFE), carbohydrates (e.g., cellulose), and/or ceramic materials.

### Additional Embodiments

A person of ordinary skill in the art will also recognize that the methods, systems and composites of the present invention can have numerous additional embodiments that have not been described here. For instance, the methods and systems of the present invention can be tailored to various sizes and shapes, along with the use of different carbon nanotubes or polymers based on the multifunctional composite requirements. The formed composites or thin films can also be cut in several ways to produce a cylindrical shape and can be further extruded to produce fiber geometries. In various embodiments, this process can be performed continuously to make continuous composite sheets, wires, and cables.

In other embodiments, a mechanical spray in a system may become clogged by polymers or carbon nanotubes. This can be overcome by periodically cleaning the mechanical spray from any polymer or carbon nanotube build up, or by having back-up or multiple spray nozzles. Alternatively, in order to ensure continuous spraying, one may desire to use an automated spray, such as an automated spray with self-cleaning abilities.

Likewise, in some embodiments, the methods and systems of the present invention may require long periods of time to produce and dry composites. This can be overcome by using a high powered vacuum pump. However, in further embodiments, B-Stage conditions might be of interest (i.e., conditions where the composite is not fully cured but rather left tacky for further processing at a later time).

Likewise, in various embodiments, the conductive plates in the systems of the present invention can be moved to other sites in the system in order to produce more carbon nanotube alignment. In further embodiments, multiple conductive plates may be used to produce more carbon nanotube alignment.

In additional embodiments, filter chambers with different dimensions, sizes, thicknesses and shapes may be utilized to produce composites with varied sizes, thicknesses and shapes. For instance, by increasing the length of one direction of the filter chamber, a long thin wire sample can be obtained. In further embodiments, a closed filter chamber may also be utilized to force solvent out of the filter chamber through mechanical pressure.

In further embodiments of the present invention, hybrid composites may be produced by utilizing different types of carbon nanotubes and polymers in a single reaction. In additional embodiments, sandwich composites with different nanotube layers coupled with different polymers can be obtained. In further embodiments, flexible composite films may be produced and fed through a hole to cause coiling up of the composite into a wire form.

In further embodiments, and as set forth previously, the alignment of carbon nanotubes in a chosen direction can be obtained by having a number of parallel or adjustable conductive plates in a system. Such systems can allow for switching of the electric field from 0° to 90°, 45° to 135°, and other desired angles.

Advantages

The methods, systems and composites of the present invention provide numerous advantages. For instance, the methods and systems of the present invention can be used to make composites that have highly dispersed and unidirectionally aligned carbon nanotubes in a polymer matrix. As set forth in the Examples below, such fabricated composites can be highly conductive and find many applications (e.g., applications as thin films or composite wires). Furthermore, the methods and systems of the present invention can be used to make such composites without requiring significant amounts of carbon nanotubes or polymers.

Moreover, the methods and systems of the present invention have an advantage over current carbon nanotube/polymer composite spray manufacturing techniques by being able to cause carbon nanotube alignment due to the addition of an electric field or magnetic field. More specifically, by adding an electric field or magnetic field to align carbon nanotubes and spraying polymers onto the aligned carbon nanotubes immediately after the alignment (in some embodiments), the methods and systems of the present invention lock the alignment of the carbon nanotubes within a composite. Accordingly, the methods and systems of the present invention enhance the electrical, thermal and mechanical properties of the formed composite.

Another advantage of the methods and systems of the present invention is the ability to horizontally align carbon nanotubes in the direction of the electric field. As also set forth in more detail in the Examples below, such horizontally aligned carbon nanotubes help produce highly conductive composites.

Applications

A person of ordinary skill in the art can also envision that the methods, systems and composites of the present invention can have numerous applications. For instance, in various embodiments, the methods and systems of the present invention may be used to produce composites that find applications as continuous wires, continuous fibers, tapes, and/or thin films. Such formed wires, fibers, tapes and/or films can subsequently find applications as lightweight alternatives to semiconductors, battery components, capacitor components, motor windings, and/or various automotive components. The composites of the present invention can also find numerous applications in oil industries, EMI shielding, and lightning strike protection. Other applications for the methods, systems and composites of the present invention can also be envisioned by persons of ordinary skill in the art.

### EXAMPLES

Reference will now be made to specific Examples relating to the methods, systems and composites of the present invention. However, Applicants note that the Examples below represent various specific and non-limiting embodiments of the present invention.

### Example 1

### Electric Field-Vacuum Spray Processing Methods

Recent interest in the improvement of electrical properties of carbon nanotube (CNT)-polymer composites has been studied in order to maximize electrical conductivity for beneficial means. While multiple methods have been created in manufacturing highly electrically conductive CNT/polymer composites, very few CNT/polymer processing methods have the ability to effectively maximize electrical conductivity. The Electric Field-Vacuum Spray (EFVS) processing method described in this Example is a novel approach to composite processing methods due to its ability to produce CNT/polymer composites with unidirectional CNT alignment within a thermoplastic polymer matrix.

This Example also discusses the advantages of EFVS processing method. In addition, this Example discusses several variables of the process that influence the electrical properties of composites containing single-wall carbon nanotubes (SWNTs) and medium density polyethylene (MDPE) (hereinafter SWNT-MDPE composites). This Example also analyzes the impact of materials used as electrodes. In addition, the Example discusses the dielectric material property effects on the electric field, and the impact of electric field strength on CNT alignment.

Introduction

Since the discovery of the high electrical conductivity properties of CNTs, research has concentrated on the goal of the exploitation and maximization of electrical conductivity CNTs without the deterioration of other CNT material properties. Several studies have researched incorporating CNTs into a polymer matrix in order to increase the electrical conductivity of the polymer while retaining mechanical stability [1-6]. Several types of polymers have been considered as possible matrices for highly conductive CNT/polymer composites, but selection of a particular polymer heavily depends on a multitude of factors that must be considered in order to meet selection criteria.

Electrical conductivity heavily depends on the ease of electron transfer throughout a material. While most polymer materials are insulators with very low electrical conductivity properties, the addition of CNTs to a polymer matrix improves the electrical conductivity of the bulk material due to CNT network formation within the composite material. CNT to CNT contact enables electron transfer throughout the polymer matrix by providing conductive pathways. The carbon surface of CNTs provides a medium for ballistic transport of electrons from one CNT to another. Disrupting CNT network formation significantly reduces the electrical resistivity of the CNT-polymer composite by either forming a resistive material barrier between CNTs or by limiting direct CNT interconnection.

Several factors play a pivotal role in the conductivity enhancement of CNT-polymer composites. Dispersion of CNTs throughout a polymer matrix allows for increased distribution of CNTs throughout the CNT-polymer composite. CNT dispersion increases CNT to CNT interconnection and network formation, further increasing electrical conductivity of the bulk material.

Research has shown that structural alignment of CNTs in a uniform direction yields higher electrical conductivity values by limiting the random dispersion of CNTs. Providing direct, unidirectional conductive pathways allows for unobstructed electron transport, further increasing electrical conductivity throughout a polymer matrix. Research has shown that applying a high voltage electric field across a mixture of CNT and low viscosity medium resulted in the unidirectional alignment of CNTs. Employing a high voltage electric field enables the manufacture of CNT-polymer composites with high electrical conductivity facilitated by unidirectional CNT alignment. Issues surrounding the ability for CNTs to align within a high viscosity polymer have surfaced since the highly viscous polymer acts as a barrier to CNT movement. However, the EFVS method unites the beneficial processing attributes of dispersion and CNT alignment by spraying a mixture of CNTs in solvent within an electric field. Unlike other CNT-polymer composite processing methods, spraying a CNT-solvent mixture rapidly disperses the mixture throughout a surface. Furthermore, employing an electric field enables CNT alignment within a low viscosity solvent.

Like other composite processing methods, several factors regarding CNT-polymer processing must be analyzed and understood in order to optimize the EFVS method. The paper will discuss processing issues of the EFVS process as well as possible solutions in order to optimize the EFVS processing method.

Electric Field-Vacuum Spray System

The EFVS method set up comprises of the following components:
Vacuum
Filter chamber
High voltage power supply
Filter
Electrical wiring
Spray system

A schematic of the EFVS method is shown in FIG. 2D. More detailed illustrations of the EFVS system are depicted in FIGS. 1 and 2A-2C.

As shown in FIG. 2D, the EFVS set up is housed within a fume hood in order to prevent circulation of aerosolized toxic solvent from affecting individuals. High temperature conductive tape secures the electrical wiring to the electrodes.

Electric Field-Vacuum Spray Method

The EFVS method consists of the preparation of solutions of CNTs in N-methylpyrrolidone (NMP) and melted MDPE in dichlorobenzene. All samples were prepared using purified HiPC® SWNTs and medium density polyethylene (MDPE). Samples were replicated at 10 wt % SWNTs in order to monitor the effects of modifications made to the EFVS system. SWNTs are dispersed in NMP using a 750 W ultrasonic probe sonicator for 45 minutes. The SWNT-NMP mixture is then decanted using a centrifuge set at 10,000 rpm to settle out larger carbon agglomerates and catalyst particles. MDPE was mixed in dichlorobenzene and heated to 120° C. using a stir plate. 50 ml aliquots of the SWNT-NMP mixture and the MDPE-DCB mixture were placed in separate containers. The MDPE-DCB mixture temperature was maintained at 120° C.

As illustrated in FIGS. 2A-2C, the vacuum filtration unit consists of a 50 mm filter siphon placed on top of a solvent collection flask. Polytetrafluoroethylene (PTFE) 47 mm diameter filter with 45 μm pore size is used as a collector. The filter chamber is placed on top of a siphon, and secured by an insulated clamp. A vacuum pump system is connected to the solvent collection flask in order to draw down solvent from the filter chamber. Conductive electrodes are secured on the outside of the filter chamber using insulating, high temperature autoclave tape. A 5 kV DC power supply is clamped to the conductive electrodes with electrical wiring. An air brush system hooked to a compressor is utilized to spray the mixtures of SWNT-NMP and MDPE-DCB into the filter chamber. A diagram depicting the EFVS processing method is shown in FIG. 2A.

The EFVS method consists of spraying alternating layers of the SWNT-NMP mixture with MDPE-DCB mixture. Spraying processing consistency is measured by having each spray reaching a depth of 2 mm within the filter chamber. Spraying the SWNT-NMP allows for the distribution of SWNT throughout the surface of the filter. Furthermore, since the SWNT are suspended in a low viscosity solvent, the high voltage electric field generates a dipole moment to form for each SWNT, allowing the SWNT to rotate in the direction of the electric field [4]. Without being bound by theory, the dipole moment is generated due to the sp² hybridization of the carbon-carbon bonding found in the SWNT structure. NMP is then filtered out of the filter chamber, leaving behind aligned SWNTs. The MDPE-DCB mixture heated to 120° C. is then sprayed on top of the aligned SWNTs to a height of 2 mm inside the filter chamber. Once sprayed, MDPE cools and crystallizes on the surface of the aligned SWNTs, locking the aligned CNT network in place. Alternate spraying of SWNT-NMP and MDPE-DCB is continued until a desired thickness is reached. FIG. 4 shows a photograph of samples processed using the EFVS method.

Electric Field-Vacuum Spray Processing Factors

Several factors impact the final SWNT/MDPE samples created using the EFVS processing method. This section will concentrate on understanding the factors that influence the electric field effectiveness of aligning SWNTs. Without being bound by theory, it is envisioned that the estimated dielectric constant between the conductive electrodes and the type of material used as conductive electrodes drastically affect the electric field strength. Understanding each of these factors will enable further optimization of the EFVS method, increasing SWNT alignment within the SWNT/MDPE composite, and electrical conductivity.

Electric Field Strength

Unidirectional alignment of the SWNTs sprayed into the filter chamber results from the applied external high voltage DC electric field. The theoretical torque experienced by a carbon nanotube due to an electric field can be expressed using the following equation:

τ=l(a [symbol] −a_{⊥})E [symbol] sin θ cos θ

In the above equation, l is the length of the carbon nanotube, a_{⊥} is the perpendicular polarizability per unit length, a [symbol] is the parallel polarizability per unit length and θ is the angle to the field. Theoretically, a [symbol] >a_{⊥} for carbon nanotubes. The DC electric field must be larger than 100 V/cm in order to induce SWNT alignment within the filter chamber [5-7]. It can be discerned that, by increasing the electric field strength, one can induce a larger torque on the carbon nanotubes within the electric field. A larger torque will further increase unidirectional alignment of the carbon nanotubes.

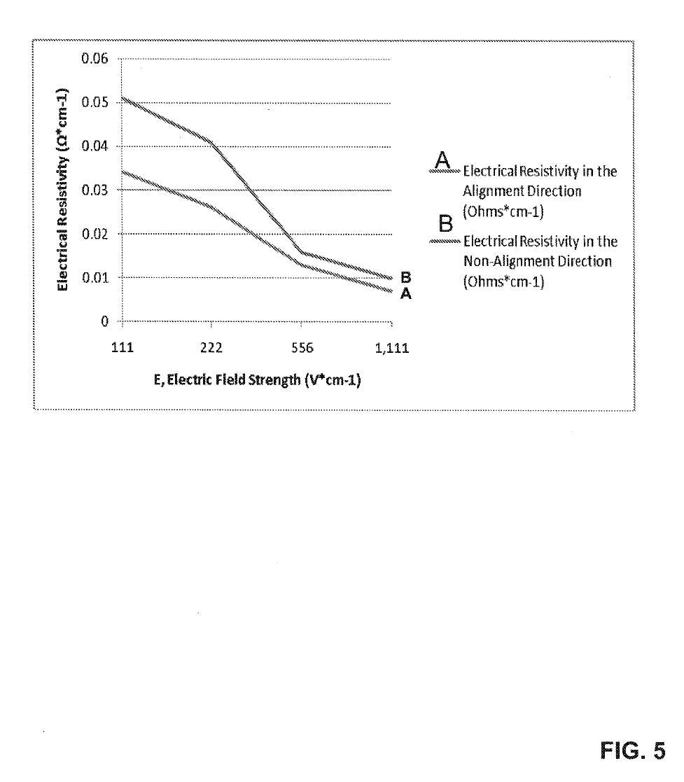

Four 10 wt % SWNT/MDPE composite samples were processed with calculated corresponding electric field strengths of 111 V/cm, 222 V/cm, 556 V/cm and 1,111 V/cm. Copper electrode materials were used to process the composite samples. Results show that increasing the electric field strength corresponds to an increase in the electrical conductivity of the processed 10 wt % SWNT/MDPE composite samples. Table 1 displays the electric field strength and resulting electrical resistivity of the 10 wt % SWNT/MDPE composite samples. FIG. 5 displays a chart that compares the electric field strength with the electrical resistivity of the 10 wt % SWNT/MDPE composite samples. It should be noted that electrical resistivity equals the inverse of electrical conductivity. Reduction of electrical resistivity yields an increased electrical conductivity.

TABLE 1
Influence of the electric field strength on the electrical conductivity of
the 10 wt % SWNT/MDPE composite samples.

| | Electrical Resistivity | |
|---|---|---|
| | in Alignment | Electrical Resistivity in Non- |
| Electric Field | Direction | Alignment Direction |
| Strength (V/cm) | (Ω cm⁻¹) | (Ω cm⁻¹) |
| 111 | 0.0343 | 0.0511 |
| 222 | 0.026 | 0.041 |
| 556 | 0.013 | 0.016 |
| 1,111 | 0.007 | 0.01 |

Formation of SWNT/MDPE Composite Samples Using the Electric Field-Vacuum Spray Processing Method

Copper plates were utilized as the electrode material. SEM characterization of the four samples revealed that samples exhibited increased unidirectional alignment with increased electric field strength. Samples processed with 111 V/cm and 222 V/cm show random SWNT network formation. FIGS. 6A and 6B show SEM images of samples processed at 111 V/cm and 1,111 V/cm, respectively. Various factors may affect the electric field strength used to align SWNTs in such composites. Such factors include dielectric permittivity and the electrode material used.

Dielectric Permittivity

Material between the conductive electrodes influences the overall strength of the electric field as a result of the material's relative dielectric permittivity. Dielectric permittivity is defined as the material resistance or response to an external electric field [5-7]. The following formula for the electrophoretic mobility of a carbon nanotube within a DC electric field displays the effects of dielectric permittivity on electric field strength:

$$μ = \frac{v}{E} = \frac{ɛζ}{η}$$

In the above formula, μ is the electrophoretic mobility, v is the drift velocity of carbon nanotube movement, E is the electric field strength, ∈ is the dielectric permittivity, ζ is the zeta potential of a carbon nanotube and η is the viscosity of the medium suspending carbon nanotube [5-9]. Rearranging the formulas yields:

$$E = \frac{\text{?}}{ɛ ζ}$$

$$\text{?} \text{indicates text missing or illegible when filed}$$

It can be discerned that reduction in dielectric permittivity results in an increase in the electric field strength and vice versa.

Materials contained between the conductive electrodes utilizing the EFVS processing method consist of the following:
Pyrex glass
N-methylpyrrolidone (NMP) (or Dichlorobenzene (DCB))
Carbon Nanotubes
Medium Density Polyethylene
Polytetrafluoroethylene (PTFE)
Air

Table 2 below displays the dielectric permittivity of each material between the conductive electrodes:

TABLE 2
Dielectric permittivity of the materials between the electric field
of the Electric Field - Vacuum Spray processing method.

| Material | Dielectric Permittivity (relative to air) |
|---|---|
| Pyrex glass | 5.1 |
| N-methylpyrrolidone (NMP) | 13.6 |
| Dichlorobenzene (DCB) | 9.93 |
| Carbon Nanotubes | 10-15 |
| Medium Density Polyethylene | 2.26 |
| Polytetrafluoroethylene (PTFE) | 2.0-2.1 |
| Air | 1 |

The calculated qualitative dielectric permittivity within the electric field can range between approximately 8.74 and 11.68 at room temperature, depending on the solvent in use as well as the type of electrode material chosen. Calculations were based on volumetric estimation of each material within the electric field. This may vary dramatically depending on chemical reactions that may form other chemical compounds within the electric field as well as the volume sprayed into the filter chamber during processing. An increased dielectric permittivity results in decreased electric field strength, reducing SWNT alignment within the 10 wt % SWNT/MDPE composite.

Electrode Material

Another factor that affects the electric field strength used to align SWNTs using the EFVS processing method is the conductive materials used as the parallel plate electrodes. The conductive electrodes used for the EFVS method act as a large parallel plate capacitor, directing an electric field across the filter chamber of the EFVS method setup. Material selection has been shown to effect the resultant SWNT alignment within the SWNT/MDPE composite samples.

Three samples were processed utilizing three different materials: copper, graphite and indium tin oxide coated glass. Each material was cut into similar dimensions of 1.25″×2.50″ in length and width. Each electrode of different material was of differing thickness due to the difficulty in cutting and sizing. Three 10 wt % SWNT/MDPE composite samples were processed using the three different materials. Electric field strength of 1,111 V/cm was utilized for processing all three samples. Electrical resistivity results from each of the three samples can be seen in Table 3 below.

TABLE 3
Electrical resistivity of three 10 wt % SWNT/MDPE composite
samples processed using the Electric Field -
Vacuum Spray processing method.

| | Electrical Resistivity in | Electrical Resistivity in |
|---|---|---|
| | Alignment Direction | Non-Alignment Direction |
| Electrode Material | (Ω cm⁻¹) | (Ω cm⁻¹) |
| Copper Metal | 0.012 | 0.017 |
| Graphite | 0.002 | 0.00204 |
| Indium Tin Oxide | 0.002 | 0.00184 |
| Coated Glass | | |

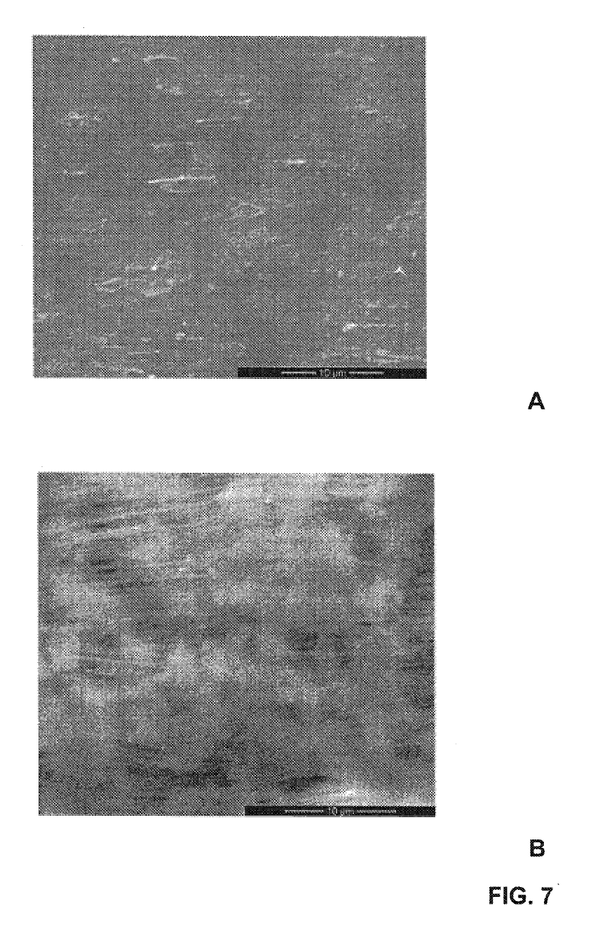

Without being bound by theory, it is hypothesized that surface formations, such as an oxide layer, resulted in an increased overall dielectric permittivity of the volume between the conductive electrodes. This increase would reduce the effective electric field strength between the conductive electrode parallel plates, which would lead to reduced SWNT alignment within the SWNT/MDPE composite. The formation of copper (II) oxide on the surface of the copper metal electrodes results in an increase in overall dielectric permittivity of the volume between the copper parallel plates due to copper (II) oxide's high dielectric permittivity (18.1). Surface formations on the surface of the graphite or indium tin oxide coated glass did not impact the electrical resistivity of the SWNT/MDPE composite samples processed due to the lower material reactivity of graphite and indium tin oxide coated glass with air chemistry. SEM images of each sample produced with differing electrode materials show little evidence of drastic reduction of SWNT alignment. FIGS. 7A and 7B show SEM images of 10 wt % SWNT/MDPE composite samples processed using graphite and indium tin oxide coated glasses, respectively.

Discussion

While the EFVS processing method presents advantages over current CNT/polymer processing methods, addressing issues that hinder the processing of CNT/polymer composites with unidirectional CNT alignment will enable further improvement of processed samples. Analysis has shown that processing CNT/polymer composite samples with a high voltage DC power supply produces increased carbon nanotube alignment within the processed samples. Furthermore, the application of a high power AC power supply has shown unidirectional CNT alignment with lower electric field strength [4-6,9]. Controlling the positioning of the conductive parallel plates can generate controlled, multi-directional CNT alignment throughout the CNT/polymer composite.

Precise quantification of the dielectric permittivity of the material within the volume between the electric field permits the precise calculation of whether the electric field used reaches the CNT alignment threshold of 100 V/cm. While the application of low dielectric permittivity materials increases the effective electric field strength, utilization of other materials may reduce efficacy of the EFVS processing method. Furthermore, multiple chemical reactions of chemicals within the filter chamber may drastically alter calculations and reduce the effective electric field applied. Projection and consideration of all possible chemical reactions facilitates increased accuracy of predicting the effective electric field strength.

Selection of particular materials used as conductive parallel plates to be used for the EFVS processing method also impacts the electrical conductivity of the EFVS processing method. Selecting conductive material with limited reactivity reduces the probability that surface formations, such as metal oxides with large dielectric permittivity, to develop. Repetitious surface cleaning of the parallel plates also reduces the chance of surface formations to occur due to the possible electrochemical reactions that may occur, depending on the chemical components found on the electrode surface.

Conclusion

The Electric Field-Vacuum Spray processing method is a novel composite processing method that incorporates the use of an electric field applied across a low viscosity solvent that produces unidirectional alignment of CNTs within a filter chamber. Furthermore, direct solidification and infiltration of a melted polymer locks aligned CNT networks in place once the polymer cools and crystallizes in place upon spraying a heated solution. These beneficial attributes allows for the processing of CNT/polymer composites with aligned CNT networks throughout the entire composite. Considering factors, such as electric field strength, dielectric permittivity of the volume between the conductive electrodes as well as material used as conductive electrodes, allows for an understanding of how to better optimize the Electric Field-Vacuum Spray processing method. Increasing the electric field strength of the EFVS processing method, reducing the dielectric permittivity of the volume between the conductive electrodes and selecting materials that have limited high dielectric permittivity surface formations allows for increased CNT alignment within CNT/polymer composites, further increasing electrical conductivity.

### REFERENCES

[1] Du, F., Fischer, J. and Winey, K. Coagulation method for preparing single-walled carbon nanotube/poly(methyl methacrylate) composites and their modulus, electrical conductivity and thermal stability. J. Polym. Sci. B Polym. Phys. 41, 3333-3338 (2003).
[2] Zhu, Y. et al. Alignment of multiwalled carbon nanotubes in bulk epoxy composites via electric field. J. Appl. Phys. 105, 054319 (2009).
[3] Walters, D. et al. In-plane-aligned membranes of carbon nanotubes. Chemical Physics Letters 338, 14-20 (2001).
[4] Park, C. et al. Aligned single-wall carbon nanotube polymer composites using an electric field. Journal of Polymer Science Part B: Polymer Physics 44, 1751-1762. 2006.
[5] Ma, C. et al. Alignment and dispersion of functionalized carbon nanotubes in polymer composites induced by an electric field. Carbon 46, 706-710. 2005.
[6] Senthil Kumar, M. et al. DC electric field assisted alignment of carbon nanotubes on metal electrodes. Solid-State Electronics 47, 2075-2080. 2003.
[7] Martin, C. et al. Electric field-induced aligned multi-wall carbon nanotube networks in epoxy composites. Polymer 46 (2005) 877-886
[8] Rogensues, A. Nanocomposite Membranes and Carbon Nanoparticle Alignment via External Fields. Department of Civil and Environmental Engineering. https://www.msu.edu/˜rogensu1/Projects_files/MiniProposal_AR.pdf
[9] Miller, L. and Mullin, J. Electronic materials: from silicon to organics. Springer. New York. 1991.

### Example 2

### Optimization of Electric Field-Vacuum Spray Processing Methods

This Example describes studies related to process optimization of the electric field-vacuum spray method. Process optimization consisted of the development of a faster process that generates thicker, larger samples in order to create wire composites. Research studies were developed in order to understand the fundamentals of CNT alignment and achieve increased uni-directional CNT alignments. Continuous samples were processed in order to continue optimization of other processing methods to create wire forms of SWNT/MDPE composites. These studies were performed in order to meet the goal of the further reduction of electrical resistivity of SWNT/MDPE composites.

Process Optimization

The current electric field-vacuum spray method of composite processing was previously described and illustrated in FIGS. 1-2. As shown in FIG. 2A, the EFVS system consists of a filter chamber 32 that holds a filter 29 at the bottom. Conductive plates 28 are secured on the outside of the vacuum chamber 26, which induces an electric field across the chamber.

Optimization of the EFVS process includes the optimization of the following parameters:
CNT alignment
Speed of processing
Process scaling

Each of the aforementioned factors will now be described in more detail below.

Carbon Nanotube Alignment

Increased alignment of CNTs while processing a CNT/MDPE composite using the EFVS method relies on the following factors:
Low viscosity solvent
High voltage electric field
CNT dispersion within solvent

Creation of a solution of CNTs suspended by a solvent is the first critical step in processing a SWNT/MDPE composite. Utilizing a low viscosity solvent allows for movement of the SWNTs within the solution due to low hindrance of the solvent. A high voltage electric field insures the induction of a dipole moment on a SWNT. It is recommended by literature to utilize minimum electric field strength of 1000 V DC. Finally, SWNT dispersion within the solvent is desirable because an over-abundance of SWNTs within a solution will cause agglomeration of the SWNTs and poor alignment. Without being bound by theory, this may be a result of weak dipole formation due to the reduced effect of the electric field on the large agglomerated mass. This large agglomerated mass of SWNTs is referred to as a “rope.”

In this study, N-Methyl-2-pyrrolidone (NMP) was utilized as the solvent to suspend the SWNTs. Dispersion of the SWNTs were performed utilizing a probe sonicator. The probe sonicator was set at 30% maximum energy for 1.5 hours, set at a 1 to 1 pulse. A high-voltage power supply was purchased in order increased the voltage across the conductive plates. The power supply has a maximum voltage output of 5000 V. This is in order to increase induced alignment of the SWNTs. The current concentration of SWNT in NMP is 0.1 mg/ml.

Speed of Processing

The speed of processing SWNT/MDPE composites using the EFVS method can depend on the following factors:
Vacuum strength
Evaporation rate of the solvent

The removal of the solvent used to suspend SWNTs in a solution can allow for the proper processing of the SWNT/MDPE composite sample. Without complete removal of the solvent, the electrical conductivity of SWNT/MDPE composites will decrease drastically as a result of the hindrance of electron transport throughout the composite materials. High vacuum strength pulls the solvent through the filter paper in order to facilitate removal. Increased evaporation rate allows for evaporation of the solvent.

The vacuum system utilized in this study was also the vacuum system shown in FIG. 2D. In order to increase the evaporation rate of the solvent, a tube was connected to the air valve and directed above the filter chamber of the setup. This allows for increased evaporation due to the decreased vapor pressure of NMP. This removes NMP vapor due to increased air circulation. Processing time of SWNT/MDPE composites was decreased.

Scaling of Process

Currently, conductive plates were fashioned at a larger size in order to be able to fit into a set up double the size of the current setup. This allows for larger samples to be processed and utilized for wire form development. FIG. 1 shows the current motorized pump assisted setup currently being considered. Another vacuum system under consideration is shown in FIG. 3, which shows the schematic of an industrial set up than can be used to process the highly conductive carbon nanotube polymer composite sheets.

Research Studies

Research studies that have been conducted include the effect of different conductive materials used as conductive plates and the effect of distance between the conductive plates on SWNT alignment.

Current deliberation over the effect of materials used as conductive plates is being considered due to the results of SEM on the currently processed samples of SWNT/MDPE composites. Initial processing of SWNT/MDPE composites was performed using glass coated with indium tin oxide. High alignment seen under SEM utilized indium tin oxide coated glass. Currently, copper plates are being utilized as conductive plates.

In some embodiments, oxide formation on the surface of the copper plates may reduce the electric field strength as a result of the cupric oxide layer with a high dielectric constant, (e.g., 18.1). High dielectric constant material in between the conductive plates is predicted to reduce the electric field strength, resulting in the decreased alignment of carbon nanotubes. This can be explained using the simplistic model that the conductive plates act as a large capacitor. Using the formula:

$$C = {ɛ}_{r} {ɛ}_{0} \frac{A}{d} ,$$

In the above formula, C is the capacitance; A is the area of overlap of the two plates; ∈r is the relative static permittivity (sometimes called the dielectric constant) of the material between the plates (for a vacuum, ∈r=1); ∈0 is the electric constant (∈0≈8.854×10−12 F m−1); and d is the separation between the plates.

Surface formations on the conductive plates are important to consider because this can add to the dielectric constant of the materials already in between the conductive plates, further reducing the effect of the electric field. A current test to see the effects of processing a sample of pure SWNTs with copper plates and graphite plates was performed.

Applicants envision that the distance in between the conductive plates also affects the strength of the electric field. Increased distance between the conductive plates reduces the strength of the electric field. Using the same simplistic model of explaining the electric field strength of the setup in relation to the capacitance of a capacitor, an increased distance between the conductive plates would decrease the capacitance, or for the electric field setup, the electric field. A current study is being developed, testing the different distances in between conductive plates and its effect on the electric field.

Processed Samples

During this time period, several samples were processed with some samples at thickness sizes much larger than before. As noted above, alignment seen in using the SEM revealed limited alignment throughout the chosen sample area. Current SEM evaluation is being constructed to obtain several samples dispersed throughout the samples in order to properly evaluate the entire processed sample.

Materials

Material selection of the polymer was limited to medium density polyethylene. Two types of carbon nanotubes were utilized to process samples: CG 100 and purified HiPC® carbon nanotubes. As noted above, NMP was utilized as the solvent to suspend the carbon nanotubes. Dichlorobenzene was chosen to suspend the melted polymer during the spray process. PTFE 0.1 micron sized pore filters were also used.

Procedure

The electric field-vacuum spray processing method was utilized to process SWNT/MDPE composites. The procedure consists of the following steps:

1. A vacuum filtration chamber is attached to the vacuum pump system.
2. Filter paper is then placed on top of the vacuum chamber.
3. The filter chamber is then secured to the vacuum filtration chamber, which also secures the filter paper.
4. Conductive plates are then secured to the vacuum filtration chamber making sure that no electric shorts can occur.
5. Vacuum pump is turned on and the conductive plates are then connected to a high voltage power supply by utilizing clamps.
6. Carbon nanotubes are well dispersed in suitable solvent and decanted to remove larger agglomerates, if any.
7. Polymer of any kind is mixed with a solvent capable of dissolving it so that the polymer/solvent solution can flow and is non viscous.
8. A mechanical spray is set up above the filter chamber and the high voltage the power supply is switched on.
9. Carbon nanotubes dispersions are sprayed into the vacuum filtration chamber and the high voltage power supply is switched on. As a result, the carbon nanotubes align in the direction of the field.
10. The polymer is immediately sprayed when the nanotubes align and form a network to lock their network and alignment formation.
11. The solvent is vacuumed out of filter chamber.
12. Steps 11 and 12 are repeated until a respective thickness is reached.
13. Electric field is turned off when all of the solvent is removed from the filter chamber.
14. Carbon nanotube/polymer composite is allowed to dry with the aid of the vacuum pump.
15. The filter paper is carefully removed from the vacuum chamber.
16. The carbon nanotube/polymer composite thin film or wire is carefully removed from the filter paper and dried for a few hours at the desired temperature.

In this study, carbon nanotube samples were processed using the previously-described EFVS process. These SWNT samples did not include any MDPE in order to test whether the 5000 V power supply would be strong enough to cause SWNT alignment.

Results

The SWNT/MDPE composites resulted in a volume resistivity range between 3.56×10⁻³ Ohm*cm to 3.43×10⁻² Ohm*cm along the aligned direction, parallel to the electric field direction. A volume resistivity range between 5.06×10⁻³ Ohm*cm to 5.11×10⁻² Ohm*cm resulted in the unaligned direction, perpendicular to the electric field direction. Table 4 below displays the results of the SWNT/MDPE composites.

| | Aligned | Non-aligned | | |
|---|---|---|---|---|
| | Direction | Direction | | Aligned |
| | Sheet | Sheet | | Direction |
| | Resistance | Resistance | | Resistivity |
| | (Ohms per | (Ohms per | Thickness | (Ohm * |
| Sample Type | square) | square) | (cm) | cm) |
| CG 100/MDP | 1.8 | 2.4 | 0.004 | 0.0072 |
| 10 wt % | | | | |
| Purified HiPCo/MDPE | 2.45 | 3.65 | 0.014 | 0.0343 |
| 10 wt % (Sample 1) | | | | |
| Purified HiPCo/MDPE | 1.3 | 1.6 | 0.01 | 0.013 |
| 10 wt % (Sample 2) | | | | |
| Purified HiPCo/MDPE | 1.78 | 2.53 | 0.002 | 0.00356 |
| 10 wt % (Sample 3) | | | | |

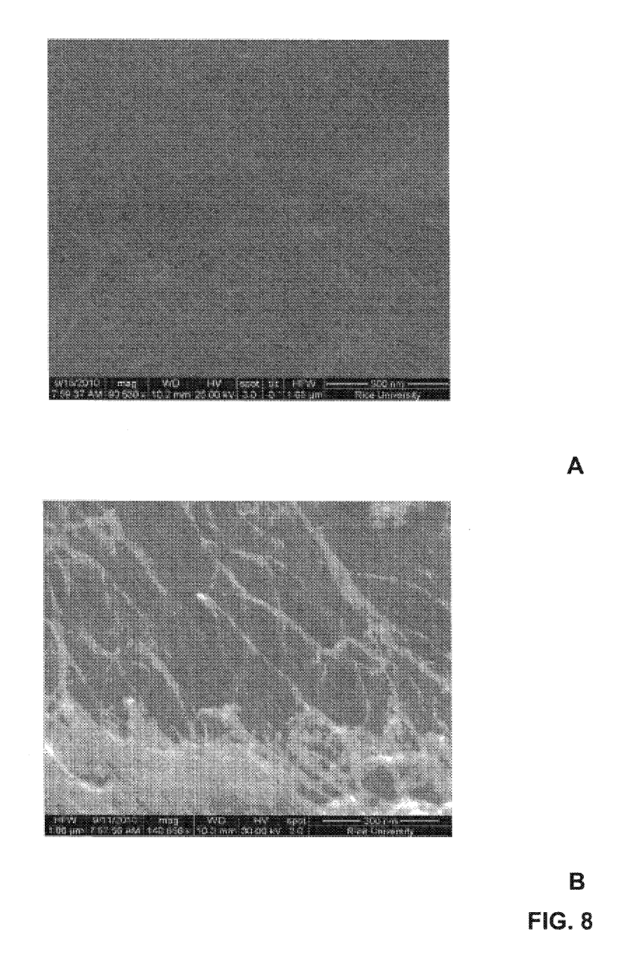

All SWNT/MDPE composite samples shown in Table 4 (unless otherwise specified) were processed utilizing copper conductive plates. SEM photographs of samples of 10 wt % HiPC® purified SWNT/MDPE composite samples revealed a non-uniform alignment of carbon nanotubes within the composite. FIG. 8A shows unaligned carbon nanotubes within the MDPE matrix. FIG. 8B reveals an aligned carbon nanotube network within the same 10 wt % purified SWNT/MDPE composite sample 2.

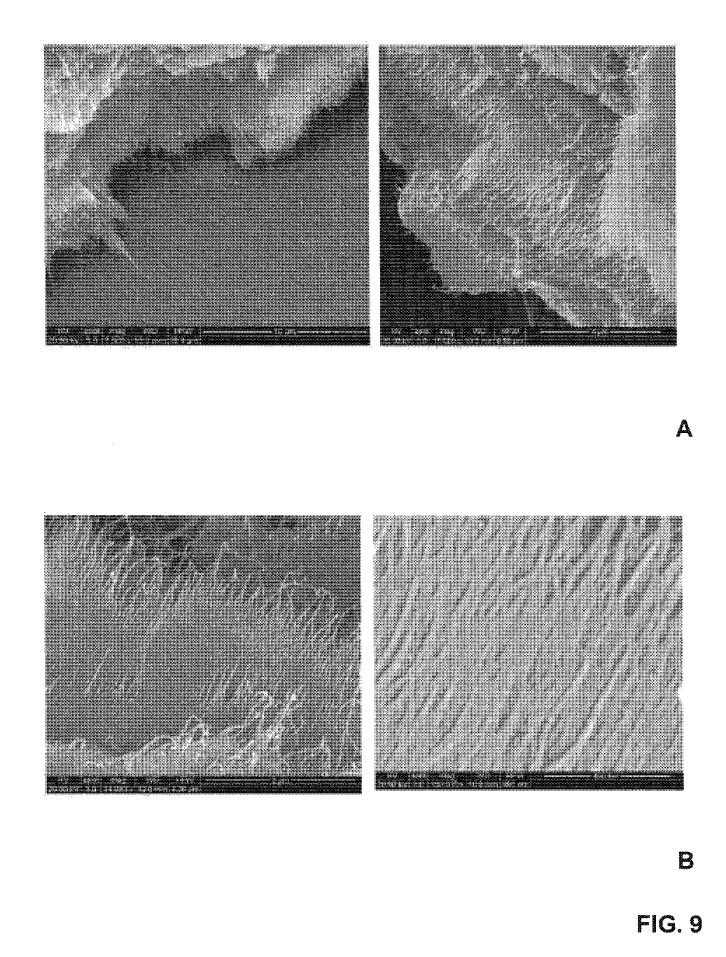

Additional SEM images are shown in FIGS. 9A and 9B. Specifically, FIGS. 9A and 9B show SEM images of 10 wt % HiPC® purified SWNT/MDPE composite samples. A net alignment of nanotubes can be seen. Furthermore, a continuous network for electron flow can be seen. Also, it can be seen that the nanotubes are well dispersed in the composite.

In additional studies, different concentrations of carbon nanotubes were used. Table 5 below shows some of the resistivity values obtained after processing of MDPE thin films with different concentrations of SWNTs.

TABLE 5
Resistivity of the MDPE/HiPco composites in the aligned direction
of SWNTs and the non-aligned direction.

| | | | Resistivity in |
|---|---|---|---|
| | | Resistivity in | the non |
| | Weight | the aligned | aligned |
| | Percent | direction | direction. |
| Sample | Nanotubes | (ohm · cm) | (ohm · cm) |
| HiPCO + MDPE | 5 | 1.61 * 10⁻¹ | 2.11 * 10 |
| HiPCO + MDPE | 10 | 4.98 * 10⁻³ | 2.68 * 10⁻² |
| (Sample 1) | | | |
| HiPCO + MDPE | 10 | 7.12 * 10⁻³ | 2.08 * 10⁻² |
| (Sample 2) | | | |

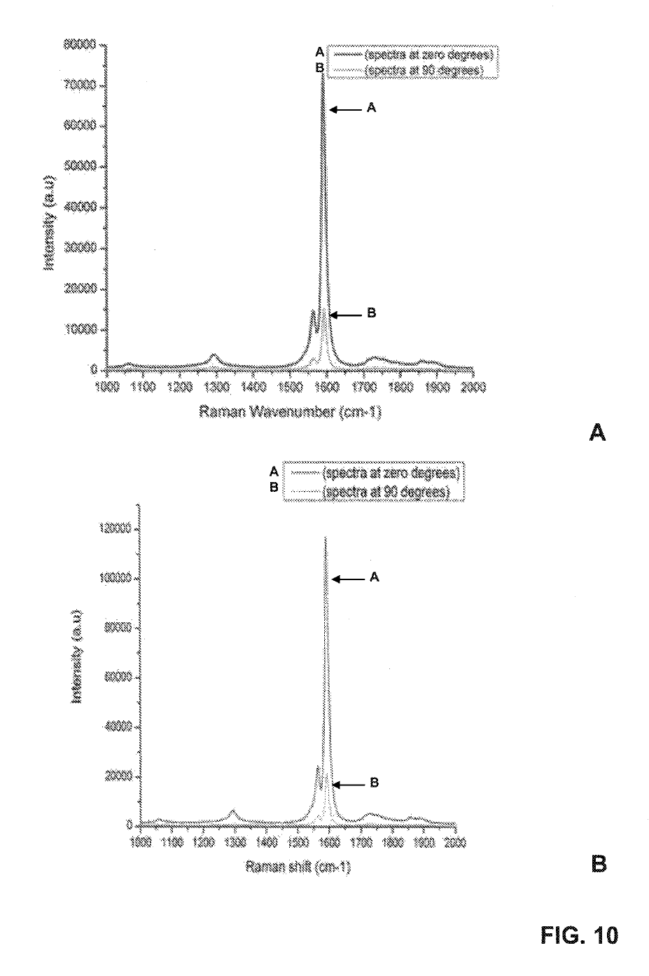

FIG. 10 shows Polarized Raman spectrua for 10 wt % HiPco/SWNT/MDPE (sample 2) composite film processed using the above EFVS method. The Raman spectra shown are aligned (FIG. 10A) and non-aligned (FIG. 10B). It can be seen that the conductivity anisotropy is about the same as polarized Raman anisotropy. In addition, the spectra show an increase in the G peak intensity for the G_{perpendicular} as compared to Gₚₐᵣₐₗₗₑₗ.

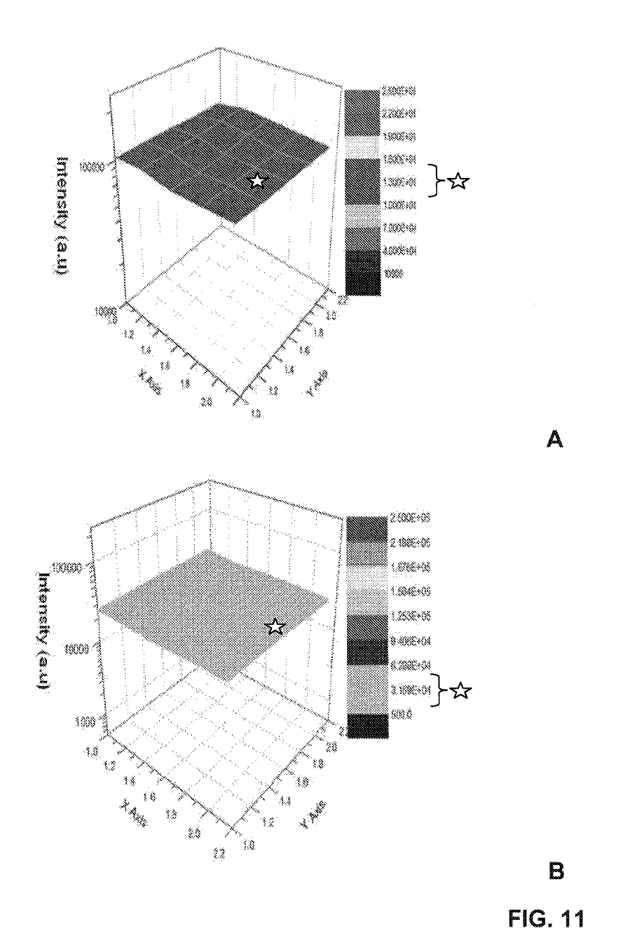

Likewise, FIG. 11 shows Raman mapping of the “G peak” intensities of 10 wt % SWNT/MDPE of aligned composites (FIG. 11A) and composites aligned in a perpendicular direction to the polarized laser beam (FIG. 11B). The spectra indicate a reduction in intensity, as shown by the map in FIG. 11B due to the alignment. The samples were collected from 40μ40μ regions using a 785 nm laser. A featureless Raman map indicates uniform dispersion of SWNTs in the area scanned. A reduction in intensity (FIG. 11B) as compared to the sample in the direction of polarized laser beam (FIG. 11A) is seen indicating alignment in the samples.

Future Work

Future process improvement will shift towards learning the fundamentals of improving the electric field strength in order to gain better alignment, and adapting the setup in order to combat any adverse effects that can reduce the electric field strength. Future research studies will address the effect of change in distance between the conductive plates and the resultant alignment of carbon nanotubes within composite samples. Furthermore, simplistic and modeled calculations of the overall dielectric constant between the conductive plates will be performed in order to better understand the effects of the material used with the electric field. This calculation will then be utilized to calculate the approximate voltage drop across the electric field in order to evaluate whether or not the voltage limit of 1000 V is reached between the conductive plates. SWNT/MDPE composite samples will continue to be processed in order to have enough bulk material to process wire samples of the SWNT/MDPE composites. Future processing of composite samples will be performed using indium tin oxide coated glass in order to achieve the same level of alignment as previously processed samples.

### REFERENCES

1. Senthil Kumar, M. et al. DC electric field assisted alignment of carbon nanotubes on metal electrodes. Solid-State Electronics 47, 2075-2080 (2003).
2. Bauhofer, W. & Kovacs, J. Z. A review and analysis of electrical percolation in carbon nanotube polymer composites. Composites Science and Technology 69, 1486-1498 (2009).
3. De, S. et al. Transparent, Flexible, and Highly Conductive Thin Films Based on Polymer-Nanotube Composites. ACS Nano 3, 714-720 (2009).
4. Hu, L., Hecht, D. S. & Gruner, G. Percolation in Transparent and Conducting Carbon Nanotube Networks. Nano Letters 4, 2513-2517 (2004).
5. Xie, X., Mai, Y. & Zhou, X. Dispersion and alignment of carbon nanotubes in polymer matrix: A review. Materials Science and Engineering: R: Reports 49, 89-112 (2005).
6. Curran, S. A. et al. Electrical transport measurements of highly conductive carbon nanotube/poly(bisphenol A carbonate) composite. J. Appl. Phys. 105, 073711 (2009).
7. Geng, H. et al. Effect of Acid Treatment on Carbon Nanotube-Based Flexible Transparent Conducting Films. Journal of the American Chemical Society 129, 7758-7759 (2007).
8. Bocharova, V. et al. Ultrathin Transparent Conductive Films of Polymer-Modified Multiwalled Carbon Nanotubes. The Journal of Physical Chemistry B 110, 14640-14644 (2006).
9. Liu, J. et al. Controlled deposition of individual single-walled carbon nanotubes on chemically functionalized templates. Chemical Physics Letters 303, 125-129 (1999).
10. Dettlaff-Weglikowska, U. et al. Conducting and transparent SWNT/polymer composites. physica status solidi (b) 243, 3440-3444 (2006).
11. Giordani, S. et al. Debundling of Single-Walled Nanotubes by Dilution: Observation of Large Populations of Individual Nanotubes in Amide Solvent Dispersions. The Journal of Physical Chemistry B 110, 15708-15718 (2006).
12. Pint, C. L. et al. Dry Contact Transfer Printing of Aligned Carbon Nanotube Patterns and Characterization of Their Optical Properties for Diameter Distribution and Alignment. ACS Nano 0,
13. Dresselhaus, M. S., Jorio, A., Hofmann, M., Dresselhaus, G. & Saito, R. Perspectives on Carbon Nanotubes and Graphene Raman Spectroscopy. Nano Letters 0,
14. Du, F. et al. Nanotube Networks in Polymer Nanocomposites: Rheology and Electrical Conductivity. Macromolecules 37, 9048-9055 (2004).
15. Ahir, S., Huang, Y. & Terentjev, E. Polymers with aligned carbon nanotubes: Active composite materials. Polymer 49, 3841-3854 (2008).
16. Baughman, R. H., Zakhidov, A. A. & de Heer, W. A. Carbon Nanotubes—the Route Toward Applications. Science 297, 787-792 (2002).
17. Dai, J., Wang, Q., Li, W., Wei, Z. & Xu, G. Properties of well aligned SWNT modified poly (methyl methacrylate) nanocomposites. Materials Letters 61, 27-29 (2007).
18. Kyrylyuk, A. V. & van der Schoot, P. Continuum percolation of carbon nanotubes in polymeric and colloidal media. Proceedings of the National Academy of Sciences 105, 8221-8226 (2008).
19. O'Connor, I., De, S., Coleman, J. N. & Gun'ko, Y. K. Development of transparent, conducting composites by surface infiltration of nanotubes into commercial polymer films. Carbon 47, 1983-1988 (2009).
20. O'Shea, J. N. et al. Electrospray deposition of carbon nanotubes in vacuum. Nanotechnology 18, 035707 (2007).
21. Pint, C. L., Xu, Y., Morosan, E. & Hauge, R. H. Alignment dependence of one-dimensional electronic hopping transport observed in films of highly aligned, ultralong single-walled carbon nanotubes. Appl. Phys. Lett. 94, 182107-3 (2009).
22. Li, C., Thostenson, E. T. & Chou, T. Effect of nanotube waviness on the electrical conductivity of carbon nanotube-based composites. Composites Science and Technology 68, 1445-1452 (2008).

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of forming a composite, wherein the method comprises:
applying carbon nanotubes onto a system, wherein the system comprises at least one of an electric field or a magnetic field, and wherein the at least one electric field or magnetic field unidirectionally aligns the carbon nanotubes; and
applying a polymer onto the carbon nanotubes while the carbon nanotubes are unidirectionally aligned by the at least one electric field or magnetic field, thereby forming composites comprising unidirectionally aligned carbon nanotubes embedded in the polymer.

2. The method of claim 1, wherein the method is repeated more than once, wherein the repetition forms a polymer composite with a plurality of layers, and wherein each layer comprises unidirectionally aligned carbon nanotubes embedded in the polymer.

3. The method of claim 1, wherein the unidirectionally aligned carbon nanotubes comprise carbon nanotubes that are horizontally aligned in the direction of the at least one electric field or magnetic field.

4. The method of claim 1, wherein the applying the carbon nanotubes onto the system comprises spraying the carbon nanotubes onto the system.

5. The method of claim 1, wherein the system comprises a vacuum filtration system comprising a filter, and wherein the carbon nanotubes and the polymer are sequentially applied onto a surface of the filter.

6. The method of claim 5, wherein the filter is a 0.2 micron filter membrane.

7. The method of claim 5, wherein the filter has a pore size from about 0.01 μm to about 50 μm.

8. The method of claim 1, wherein the unidirectionally aligned carbon nanotubes comprise a continuous network of carbon nanotubes.

9. The method of claim 1, wherein the method is used for the production of at least one of continuous wires, continuous fibers, continuous tapes, and thin films.

10. The method of claim 1, wherein the carbon nanotubes are selected from the group consisting of single-wall carbon nanotubes, double-wall carbon nanotubes, multi-wall carbon nanotubes, ultrashort carbon nanotubes, and combinations thereof.

11. The method of claim 1, wherein the carbon nanotubes comprise functionalized carbon nanotubes.

12. The method of claim 1, wherein the carbon nanotubes comprise pristine carbon nanotubes.

13. The method of claim 1, wherein the carbon nanotubes comprise single-wall carbon nanotubes.

14. The method of claim 1, wherein the carbon nanotubes are in a solution.

15. The method of claim 14, wherein the solution comprises N-methylpyrrolidone.

16. The method of claim 1, wherein the applying the polymer onto the carbon nanotubes comprises spraying the polymer onto the carbon nanotubes.

17. The method of claim 1, wherein the polymer is selected from the group consisting of polyethylenes, polyurethanes, polystyrenes, polyvinyl chlorides, polymethyl methacrylates, polyvinyl alcohols, polyethylene glycols, poly(ethylene terephthalate), epoxy polymers, and combinations thereof.

18. The method of claim 1, wherein the polymer is medium density polyethylene.

19. The method of claim 1, wherein the polymer is in a solvent.

20. The method of claim 19, wherein the solvent is selected from the group consisting of toluenes, xylenes, dimethylformamides, methylpyrrolidones, chloroform, benzenes, and combinations thereof.

21. The method of claim 20, wherein the solvent comprises dichlorobenzene.

22. The method of claim 1, wherein the system comprises an electric field.

23. The method of claim 1, wherein the electric field is introduced to the system by conductive plates, wherein the conductive plates are selected from the group consisting of copper plates, aluminum plates, graphite plates, tin oxide plates, and combinations thereof.

24. The method of claim 1, wherein the system further comprises a plurality of parallel conductive plates or adjustable conductive plates, wherein the parallel or adjustable conductive plates allow for adjusting a direction of the at least one electric field or magnetic field, and wherein the adjusting allows for the formation of unidirectionally aligned carbon nanotubes at various desired angles.

25. The method of claim 24, wherein the desired angles range from about 0° to about 135°.

26. The method of claim 1, wherein the system comprises a magnetic field.

27. The method of claim 1, wherein the at least one electric field or magnetic field is actuated before the applying of the carbon nanotubes onto the system.

28. The method of claim 1, wherein the at least one electric field or magnetic field is actuated during the applying of the carbon nanotubes onto the system.

29. The method of claim 1, wherein the at least one electric field or magnetic field is actuated after the applying of the carbon nanotubes onto the system.

30. A polymer composite comprising:
a polymer, wherein the polymer forms a polymer matrix; and
a plurality of carbon nanotubes, wherein the carbon nanotubes are unidirectionally aligned, and wherein the carbon nanotubes are embedded in the polymer matrix.

31. The polymer composite of claim 30, wherein the polymer composite comprises a plurality of layers, and wherein each layer comprises unidirectionally aligned carbon nanotubes embedded in a polymer matrix.

32. The polymer composite of claim 30, wherein the unidirectionally aligned carbon nanotubes comprise carbon nanotubes that are horizontally aligned.

33. The polymer composite of claim 30, wherein the unidirectionally aligned carbon nanotubes are aligned at a desired angle.

34. The polymer composite of claim 33, wherein the desired angle ranges from about 0° to about 135°.

35. The polymer composite claim 30, wherein the unidirectionally aligned carbon nanotubes comprise a continuous network of carbon nanotubes.

36. The polymer composite of claim 30, wherein the carbon nanotubes are selected from the group consisting of single-wall carbon nanotubes, double-wall carbon nanotubes, multi-wall carbon nanotubes, ultrashort carbon nanotubes, and combinations thereof.

37. The polymer composite of claim 30, wherein the carbon nanotubes comprise functionalized carbon nanotubes.

38. The polymer composite of claim 30, wherein the carbon nanotubes comprise pristine carbon nanotubes.

39. The polymer composite of claim 30, wherein the carbon nanotubes comprise single-wall carbon nanotubes.

40. The polymer composite of claim 30, wherein the polymer is selected from the group consisting of polyethylenes, polyurethanes, polystyrenes, polyvinyl chlorides, polymethyl methacrylates, polyvinyl alcohols, polyethylene glycols, poly(ethylene terephthalate), epoxy polymers, and combinations thereof.

41. The polymer composite of claim 30, wherein the polymer is medium density polyethylene.

42. The polymer composite of claim 30, wherein the polymer composite comprises at least one of continuous wires, continuous fibers, continuous tapes, and thin films.
